(19) United States
(12) Patent Application Publication
(10) Pub. No.: US 2026/0217329 A1
(43) Pub. Date: Jul. 30, 2026

(54) IMAGE DISPLAY SYSTEM

(71) Applicant: KABUSHIKI KAISHA TOKAI-RIKA-DENKI-SEISAKUSHO, Niwa-gun, Aichi (JP)

(72) Inventors: Tomonori ICHIKAWA, Niwa-gun, Aichi (JP); Furuna YAMAMOTO, Niwa-gun, Aichi (JP); Toshinari NAKAI, Niwa-gun, Aichi (JP)

(21) Appl. No.: 19/142,572

(22) PCT Filed: Dec. 11, 2023
(86) PCT No.: PCT/JP2023/044318

§ 371 Date: Jun. 23, 2025

(30) Foreign Application Priority Data
Dec. 23, 2022 (JP) 2022-207658

(51) Int. Cl. B62J 50/22; G06T 3/40; G06T 3/60

(52) U.S. Cl. CPC B62J 50/22; G06T 3/40; G06T 3/60

(57) ABSTRACT

A image display system includes: an imaging device that images an area behind a motorcycle; a display device that is attached to the motorcycle so as to be located in front of a rider, is attachable with a changed orientation or is capable of changing an orientation in an attachment state, and displays an image based on image data acquired from the imaging device; and a control device that is configured to control the display device so as to cut out a region determined according to the attachment state of the display device from an imaging range of a captured image imaged by the imaging device and display an image corresponding to the cut out region.

### TECHNICAL FIELD

The present disclosure relates to an image display system.

### BACKGROUND ART

Conventionally, there is known a technique of displaying a rear view image capturing a rear area with respect to a two-wheeled vehicle on a display device and providing visual information regarding the rear area of the two-wheeled vehicle to a rider. For example, Japanese Patent Application Laid-Open No. 2013-60128 discloses a rear view image display device that displays a partial region of a captured image obtained by imaging to the rear of a two-wheeled vehicle on a display device disposed near a steering wheel.

### SUMMARY OF INVENTION

### Technical Problem

However, in the case of a motorcycle such as a two-wheeled motorcycle and a three-wheeled motorcycle, an arrangement space of the display device is limited as compared with a vehicle. For this reason, there may be a restriction that the display device can be arranged only vertically or only horizontally.

An object of the disclosure is to provide an image system capable of improving mountability of a display device by allowing a horizontal arrangement and a vertical arrangement of the display device that displays a rear view image of a motorcycle. Note that the “image” in the disclosure includes a video and a still image.

### Solution to Problem

A image display system according to a first aspect of the disclosure includes: an imaging device that images an area behind a motorcycle; a display device that is attached to the motorcycle so as to be located in front of a rider, is attachable with a changed orientation or is capable of changing an orientation in an attachment state, and displays an image based on image data acquired from the imaging device; and a control device that is configured to control the display device so as to cut out a region determined according to the attachment state of the display device from an imaging range of a captured image imaged by the imaging device, and display an image corresponding to the cut out region.

According to a second aspect of the disclosure, in the image display system according to the first aspect of the disclosure, the region is a horizontally long region when the attachment state of the display device is a horizontal arrangement, and the region is a vertically long region when the attachment state of the display device is a vertical arrangement.

According to a third aspect of the disclosure, in the image display system according to the first or second aspect of the disclosure, the display device includes a detection mechanism that detects an orientation of the display device, and the control device cuts out the region determined according to the attachment state of the display device based on a detection result of the detection mechanism.

According to a fourth aspect of the disclosure, in the image display system according to any one of the first to third aspects of the disclosure, the control device cuts out the region determined according to the attachment state of the display device such that a magnification of the image displayed on the display device is constant regardless of whether the attachment state of the display device is a horizontal arrangement or a vertical arrangement.

According to a fifth aspect of the disclosure, in the image display system according to any one of the first to fourth aspects of the disclosure, the control device controls the display device to display an additional screen together with the image cut out from the captured image when the attachment state of the display device is one of a horizontal arrangement or a vertical arrangement, and to display the image cut out from the captured image without displaying the additional screen when the attachment state of the display device is another of the horizontal arrangement or the vertical arrangement.

According to a sixth aspect of the disclosure, in the image display system according to any one of the first to fifth aspects of the disclosure, when the additional screen is displayed together with an image of the area behind the motorcycle, the control device controls the display device such that the image cut out from the captured image is arranged on a center side of a vehicle body with respect to the additional screen.

### ADVANTAGEOUS EFFECTS OF INVENTION

According to the image display system of the first aspect of the disclosure, the display device that displays the rear view image of the motorcycle can be attached to the motorcycle in both the horizontal arrangement and the vertical arrangement, and mountability of the display device can be improved.

According to the image display system of the second aspect of the disclosure, it is possible to display an image suitable for the attachment state of the display device.

According to the image display system of the third aspect of the disclosure, the orientation of the display device can be automatically determined.

According to the image display system of the fourth aspect of the disclosure, regardless of the attachment state of the display device, the range that the rider wants to see can be displayed at a magnification at which the rider can easily grasp a sense of distance.

According to the image display system of the fifth aspect of the disclosure, the presence or absence of display of the additional screen can be determined according to the attachment state of the display device.

According to the image display system of the sixth aspect of the disclosure, it is possible to display the additional screen together with the image while reducing the offset amount in the left-right direction of the rear view image.

### BRIEF DESCRIPTION OF DRAWINGS

FIG. 1 is a schematic diagram illustrating an example of a configuration of an image display system according to a first embodiment of the disclosure.

FIG. 2A is a schematic view illustrating an example of an arrangement of a display device.

FIG. 2B is a schematic view illustrating an example of an arrangement of the display device.

FIG. 2C is a schematic view illustrating an example of an arrangement of the display device.

FIG. 2D is a schematic view illustrating an example of an arrangement of the display device.

FIG. 3 is a schematic view illustrating an example of a bracket of the display device.

FIG. 4 is a block diagram illustrating an example of an electrical configuration of an image display system according to an embodiment of the disclosure.

FIG. 5 is a functional block diagram illustrating an example of a functional configuration of a control device.

FIG. 6 is a flowchart illustrating an example of a flow of processing of the image display program according to the first embodiment of the disclosure.

FIG. 7 is a flowchart illustrating an example of a flow of generation processing of display image data.

FIG. 8A is a schematic diagram for explaining processing of image data according to the first embodiment of the disclosure.

FIG. 8B is a schematic diagram for explaining processing of image data according to the first embodiment of the disclosure.

FIG. 8C is a schematic diagram for explaining processing of image data according to the first embodiment of the disclosure.

FIG. 9 is a schematic diagram illustrating an example of a setting screen used in an image display system according to a second embodiment of the disclosure.

FIG. 10 is a schematic diagram illustrating an example of a display image for displaying an additional screen and a rear view image.

FIG. 11 is a flowchart illustrating an example of a flow of “generation processing of display image data” according to the second embodiment of the disclosure.

FIG. 12A is a schematic diagram illustrating an example of a layout of an additional screen in a case where the display device is arranged horizontally.

FIG. 12B is a schematic diagram illustrating an example of a layout of an additional screen in a case where the display device is arranged horizontally.

FIG. 13A is a schematic diagram illustrating another example of the layout of the additional screen in a case where the display device is arranged vertically.

FIG. 13B is a schematic diagram illustrating another example of the layout of the additional screen in a case where the display device is arranged vertically.

FIG. 14 is a schematic view illustrating an example of a display device and a bracket in an image display system according to a third embodiment of the disclosure.

FIG. 15A is an explanatory view of a method of detecting an attachment state of a display device according to the third embodiment of the disclosure.

FIG. 15B is an explanatory view of the method for detecting the attachment state of the display device according to the third embodiment of the disclosure.

FIG. 15C is an explanatory view of the method for detecting the attachment state of the display device according to the third embodiment of the disclosure.

FIG. 15D is an explanatory view of the method for detecting the attachment state of the display device according to the third embodiment of the disclosure.

### DESCRIPTION OF EMBODIMENTS

Hereinafter, embodiments of the disclosure will be described in detail with reference to the drawings.

### First Embodiment

An image display system of the disclosure is an image display system for a motorcycle, and displays an image behind an own vehicle to a rider. Here, the “motorcycles” means two-wheeled motorcycles, three-wheeled motorcycles, or four-wheeled motorcycles among saddle-style vehicles that a rider rides by straddling the vehicle. Examples of the motorcycle include one using an engine as a driving source and one using a motor as a driving source. Examples of the motorcycle include, for example, a motorcycle, a scooter, and an electrically powered scooter. Hereinafter, a case in which the motorcycle is a two-wheeled motorcycle will be described.

### Configuration of Video Display System

First, a configuration of an image display system will be described.

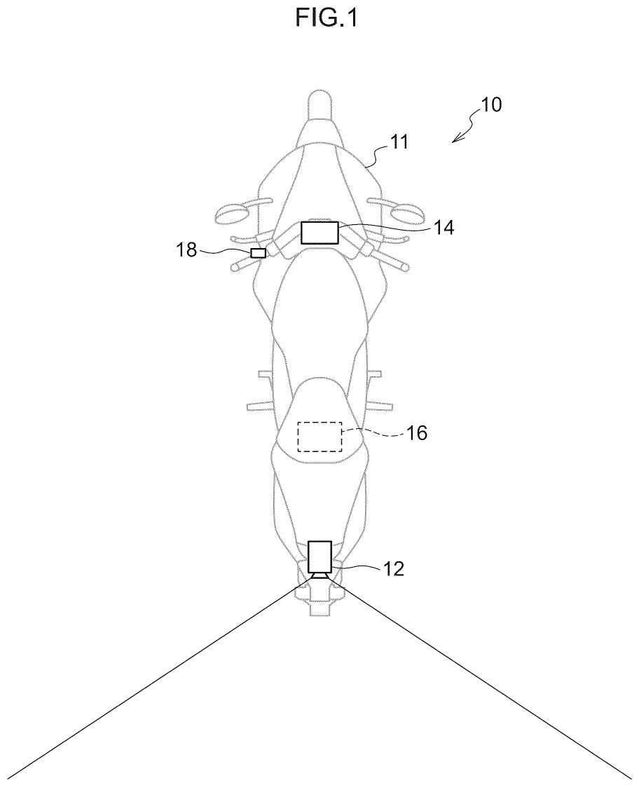

FIG. 1 is a schematic diagram illustrating an example of a configuration of the image display system. As illustrated in FIG. 1, an image display system 10 includes an imaging device 12, a display device 14, a control device 16, and an operation device 18. Although one of each device is illustrated in FIG. 1, a plurality of imaging devices 12, a plurality of display devices 14, and a plurality of operation devices 18 may be provided.

The imaging device 12 is a device that images the rear of a vehicle body 11 of the motorcycle. As the imaging device 12, for example, a digital image camera including an image sensor such as a CCD image sensor or a CMOS image sensor can be used.

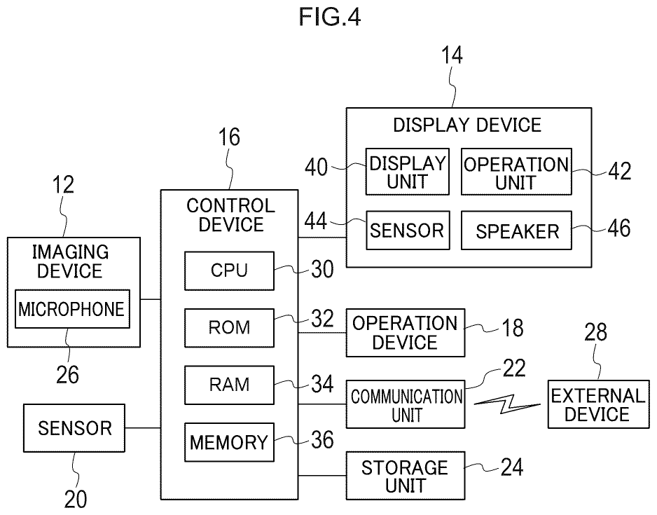

The display device 14 is a device that displays an image behind the vehicle to the rider. As a display unit 40 (see FIG. 4) of the display device 14, for example, a display such as a liquid crystal display, an organic EL display, or a touch panel display having a configuration in which a touch panel is superimposed on these displays can be used. The display device 14 is installed at a position in front of the rider where the rider can easily see the display device.

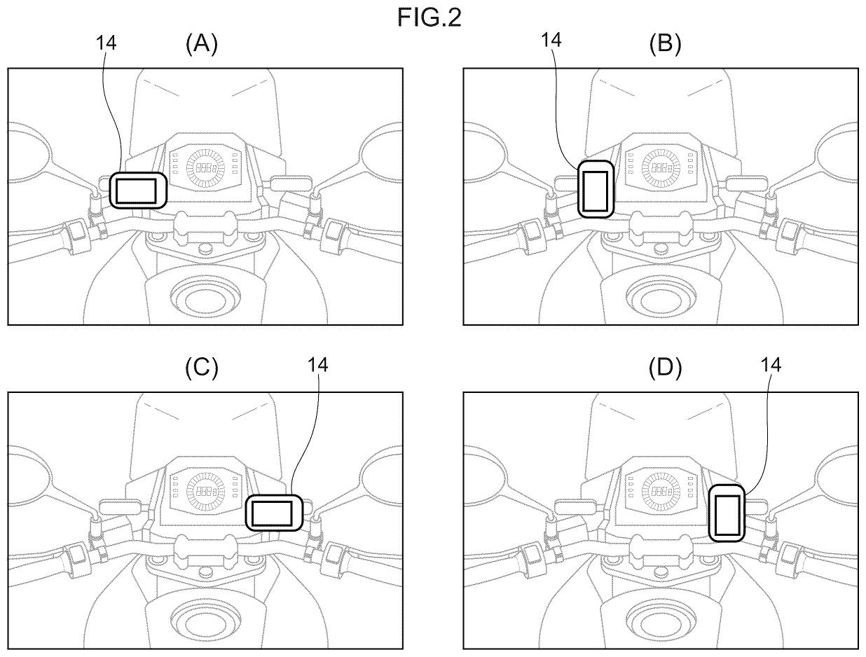

The display device 14 is a display device that is attached later, different from a display provided on an instrument panel of the vehicle body 11. For example, as illustrated in FIG. 2, when a meter display for displaying vehicle information is disposed at the center of the instrument panel, the display device 14 can be disposed near the meter display. When the display device 14 is disposed, the distance from the rider to the instruments (for example, a meter display) and the distance from the rider to the display device 14 are made substantially the same, so that the rider can easily focus on the display device 14.

In FIG. 2A, the display device 14 is attached horizontally on the left side of the meter display, and in FIG. 2B, the display device 14 is attached vertically on the left side of the meter display. In FIG. 2C, display device 14 is attached horizontally on the right side of the meter display, and in FIG. 2D, display device 14 is attached vertically on the right side of the meter display. Here, the right side and the left side are the right side and the left side with respect to the vehicle traveling direction, and correspond to the right side and the left side when viewed from the rider.

The display device 14 is attached to the vehicle body 11. For example, the display device 14 may be attachable by changing an orientation such that the orientation is fixed when attached. In addition, the orientation of the display device 14 may be changeable in the attached state so that the orientation can be changed even after the attachment.

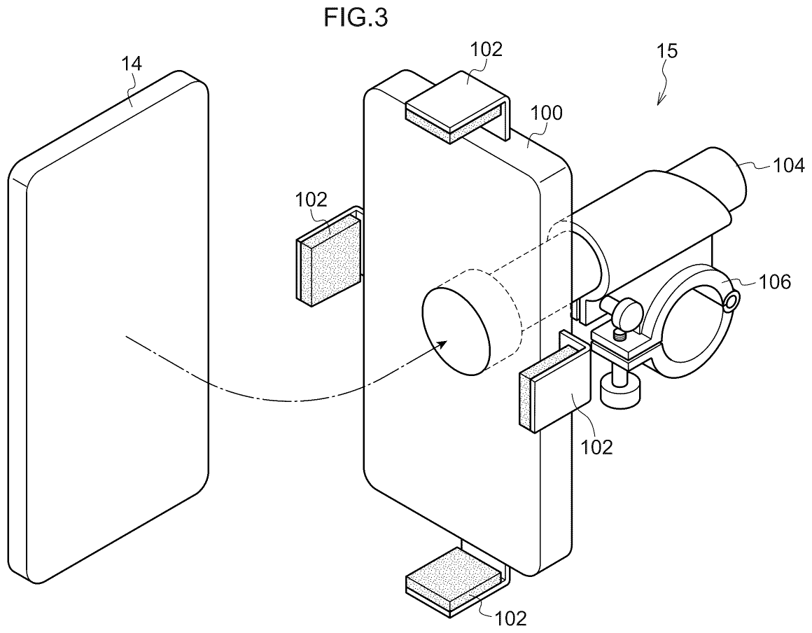

For example, by attaching the display device 14 via a bracket 15 as illustrated in FIG. 3, the orientation of the display device 14 can be changed even after the attachment. The bracket 15 includes a flat plate-shaped holding portion 100 that holds the display device 14, a fixing portion 102 that fixes the display device 14 to the holding portion 100, a cylindrical support portion 104 that supports the holding portion 100, and an attachment portion 106 that fixes the support portion 104. The attachment portion 106 is attached to, for example, a steering wheel or the like.

A circular hole is provided at the center of the holding portion 100. An end of the support portion 104 is fitted into the circular hole. Thus, the holding portion 100 is rotatably supported around the support portion 104 by the support portion 104. The end surface of the support portion 104 is exposed from the holding surface of the holding portion 100. The display device 14 is attached to the vehicle body 11 together with the bracket 15 by the attachment portion 106. According to such a bracket 15, even after the display device 14 is attached to the vehicle body 11, the orientation of the display device 14 can be changed by rotating the holding portion 100.

The control device 16 is a control function unit of an electronic control unit (ECU) provided to control the display device 14. The control device 16 is installed inside the vehicle body 11, for example, by being embedded inside a seat.

The operation device 18 is a device for the rider to perform operation input. As the operation device 18, a steering wheel switch or the like attached near the steering wheel can be used. According to the steering wheel switch, the rider can perform operation input even while traveling. The operation device 18 can be attached to the left grip, for example.

### Electrical Configuration of Video Display System

Next, an electrical configuration of the image display system 10 will be described.

FIG. 4 is a block diagram illustrating an example of an electrical configuration of the image display system 10. The control device 16 includes a central processing unit (CPU) 30, a read only memory (ROM) 32, a random access memory (RAM) 34, and a non-volatile memory 36. The ROM 32 or the non-volatile memory 36 stores in advance a image display program to be described below. The CPU 30 reads a program stored in advance, and executes the program using the RAM 34 as a work area.

The imaging device 12, the display device 14, and the operation device 18 are connected to the control device 16 in a wired or wireless manner so as to be able to exchange data with the control device 16. In addition, various sensors 20, a communication unit 22, and a storage unit 24 are also connected to the control device 16 in a wired or wireless manner so as to be able to exchange data with the control device 16. The control device 16 exchanges information with each unit and controls each unit.

The sensor 20 is an inclination sensor, an acceleration sensor, or the like for detecting the inclination of the vehicle body 11. The communication unit 22 is an interface for communicating with an external device 28. The storage unit 24 is an external storage device such as a hard disk drive (HDD) or a memory card (for example, an SD card). The storage unit 24 stores image data and the like of various screens to be described below. The control device 16 is accommodated in a case together with the communication unit 22 and the storage unit 24, and is installed inside the vehicle body 11 as an ECU.

The display device 14 includes a display unit 40, an operation unit 42, a sensor 44, a speaker 46, and the like. The display unit 40 is a display for displaying an image on the basis of the image data. The operation unit 42 is a switch or a button for performing an operation input. The sensor 44 is, for example, an acceleration sensor. The acceleration sensor is an example of a detection mechanism that detects the orientation of the display device. The speaker 46 is a device that outputs an audio on the basis of audio data.

The configuration described above is an example, and other members can be added or some members can be omitted. For example, the image display system 10 may include a microphone 26 for collecting sounds around the vehicle. The microphone 26 may be, for example, a microphone built into the imaging device 12 as illustrated.

Here, the operation of the image display system 10 will be briefly described.

A image behind the vehicle is captured by the imaging device 12, and the obtained image data is output to the control device 16. The control device 16 processes the obtained image data according to an attachment state (for example, the orientation and the distinction between the right and left) of display device 14, and outputs the processed image data to display device 14. The display device 14 displays an image on the basis of the obtained image data.

The attachment state of the display device 14 may be automatically determined on the basis of detection data or the like of an acceleration sensor of the display device 14, or may be manually set by the rider. The operation input by the rider can be performed through the operation device 18, can be performed through the operation unit 42 of the display device 14, or can be performed through an operation screen displayed on the display unit 40 of the display device 14.

### Functional Configuration of Control Device

Next, a functional configuration of the control device 16 will be described.

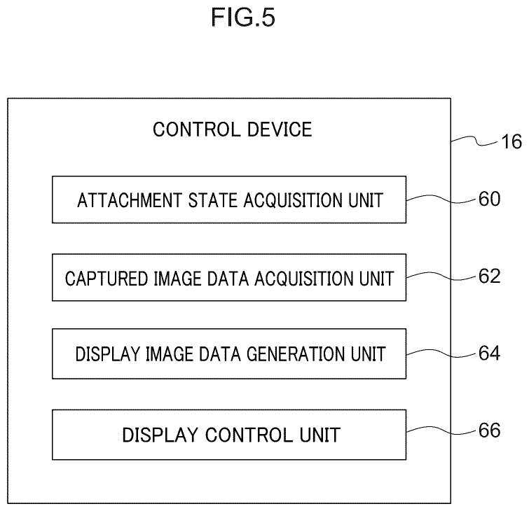

FIG. 5 is a functional block diagram illustrating an example of a functional configuration of the control device 16. The control device 16 includes an attachment state acquisition unit 60, a captured image data acquisition unit 62, a display image data generation unit 64, and a display control unit 66. Each of these functional units is implemented by the CPU 30 of the control device 16 executing a image display program to be described below.

### Video Display Program

Next, the image display program will be described.

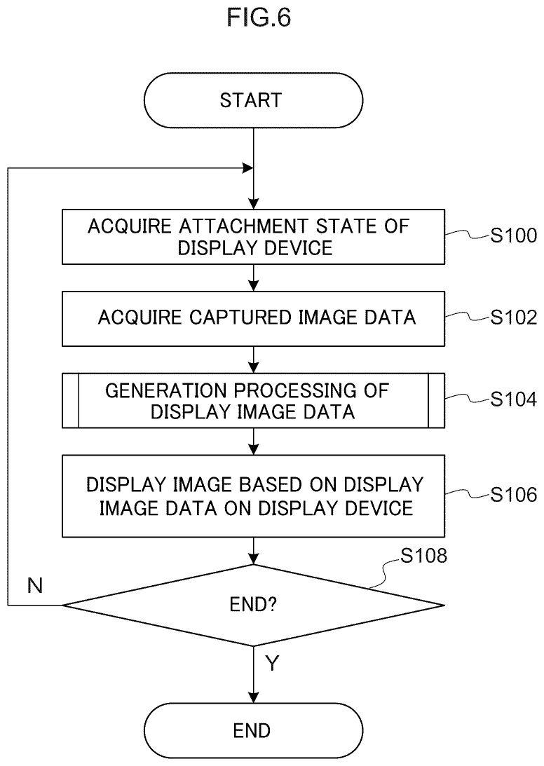

FIG. 6 is a flowchart illustrating an example of a flow of processing of the image display program. The image display program is executed by the CPU 30 of the control device 16, and is started when an instruction to display an image is given. The instruction to display the image may be performed by operating the operation device 18, for example. Here, except for step S108, the operation of the CPU 30 will be described as the operation of each functional unit illustrated in FIG. 5.

First, in step S100, the attachment state acquisition unit 60 acquires the attachment state based on detection data of the sensor 20 (for example, an acceleration sensor) of the display device 14. In the detection data of the sensor 20, it is not possible to determine which one of the left and right sides of the meter display the display device 14 is disposed on. Therefore, it is assumed here that the distinction between left and right sides are known. Therefore, whether the display device 14 is arranged vertically or horizontally is automatically determined from the detection data of the acceleration sensor.

Next, in step S102, the captured image data acquisition unit 62 acquires the image data from the imaging device 12. Here, the unprocessed image data obtained from the imaging device 12 is referred to as captured image data.

Next, in step S104, the display image data generation unit 64 executes generation processing of display image data. Here, the image data for display to be displayed on the display device 14 is referred to as display image data.

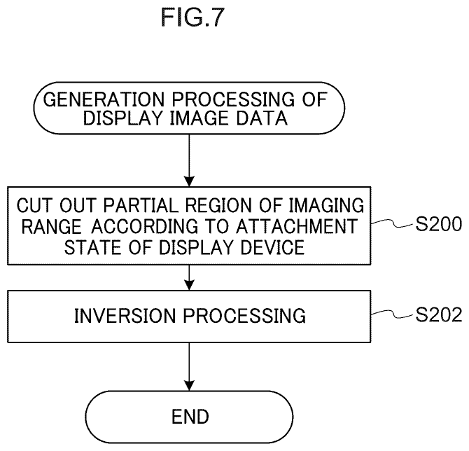

As illustrated in FIG. 7, in the generation processing of the display image data, in step S200, the display image data generation unit 64 performs image processing on the captured image data so as to cut out a partial region of the imaging range as the display range according to the attachment state of the display device, and in subsequent step S202, performs image processing on the obtained image data so as to laterally invert the image of the display range, thereby generating the display image data. The reason why the inverted image is displayed is that the rider can easily ascertain the situation behind in the same direction as the mirror image reflected on the optical mirror for rear check. Note that after switching the order of step S200 and step S202 and inverting the image, a partial region may be cut out.

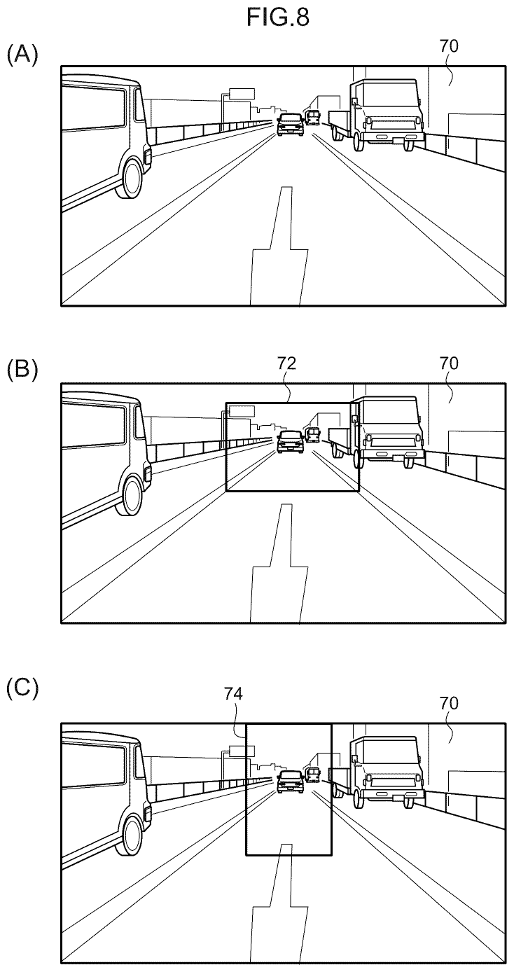

FIG. 8A is a view illustrating a captured image 70 based on the captured image data. As illustrated in FIG. 8B, when the display device 14 is attached in the horizontally-long arrangement, the display image data generation unit 64 cuts a region 72 having a horizontally-long shape out of the imaging range of the captured image 70 to set the cut-out region as the display range. The imaging device 12 captures an image of a wide area behind the vehicle, but the rider wants to see an area around the blind spot right behind the rider. The captured image is captured such that the blind spot area is at the center of the imaging range. Therefore, the display image data generation unit 64 cuts out the region 72 so as to hold the central portion of the imaging range to set the region as the display range. By cutting out and displaying a part of the region 72, a range that the rider wants to see can be displayed large.

On the other hand, as illustrated in FIG. 8C, in a case where the display device 14 is attached in the vertical arrangement, the display image data generation unit 64 cuts out a vertically long region 74 from the imaging range of the captured image 70 to set the cut-out region as the display range. By cutting out and displaying a part of the region 74, a range that the rider wants to see can be displayed large. The region 74 is different in shape from the region 72, but is cut out so as to hold the central portion of the imaging range similarly to the region 72. In addition, the region 72 and the region 74 are preferably cut out such that the display image has substantially the same magnification. For example, the magnification can be set to a magnification at which the displayed image has the same size as the mirror image of the optical mirror so that the rider can easily grasp the sense of distance.

Note that, in the above example, the display range is cut out so as to hold the center of the imaging range. However, an object (for example, a following vehicle or the like) in a blind spot area may be detected, and the display range may be cut out so that the object is displayed at the center. Furthermore, in the generation processing of the display image data, the display image data generation unit 64 can also perform other image processing such as rotation correction, distortion correction, color correction, noise removal, and the like.

The description returns to FIG. 6. Next, in step S106, the display control unit 56 outputs the display image data to the display device 14, and causes the display device 14 to display an image based on the display image data.

Next, in step S108, the CPU 30 determines whether or not to end the image display. For example, when the end of the image display is instructed by the operation of the operation device 18, the CPU 30 makes a YES determination in step S108 and ends the routine. For example, when the end of the image display is instructed from the rider during traveling, the CPU 30 ends the image display and also ends the routine. On the other hand, when the image display is not ended, the CPU 30 makes a NO determination in step S108, and the processing returns to step S100. Therefore, the process of steps S100 to S108 is repeatedly executed until the end of the image display is instructed.

As described above, according to the image display system according to the first embodiment, various effects as described below can be obtained.

(1) Although the imaging device captures an image of a wide range behind the own vehicle, an image obtained by cutting out a region that the rider wants to see in the imaging range is displayed on the display device disposed in front of the rider while the rider is traveling. Therefore, the range that the rider wants to see is displayed large, and the visibility is improved. In addition, the rider can check a blind spot area right behind, and the rear check is facilitated. Furthermore, since the rear check is facilitated, the head swing motion of the rider can be reduced, and improvement in safety is expected.

(2) The image display system cuts out the display area from the imaging range according to the attachment state of the display device, but the display area is cut out so as to hold the central portion of the imaging range regardless of the attachment state. Therefore, a blind spot area right behind the rider that the rider wants to see is displayed, and even if the display device is attached in either the horizontal arrangement or the vertical arrangement, it is possible to display an image suitable for rear check.

### Second Embodiment

In the first embodiment, an example in which the image display system displays only the rear view image on the display device has been described, but in a second embodiment, an example in which the image display system displays an additional screen together with the rear view image will be described. In the first embodiment, the attachment state of the display device is automatically determined, but in the second embodiment, the rider manually sets the attachment state of the display device.

Examples of the additional screen include a screen for displaying specific information such as a navigation screen and a screen for receiving an operation input such as a menu screen. Here, the menu screen is a screen that is first displayed to select an item to be operated/set. Furthermore, it is also assumed that the image display system 10 (see FIG. 4) cooperates with an external information processing device such as a smartphone. In such a case, a screen of various application programs such as a map application and a call application may be displayed as the additional screen.

The second embodiment is different from the first embodiment in an image displayed on display device 14, a flow of generation processing of display image data executed as a subroutine of an image display program, and a method of setting an attachment state of the display device. Therefore, description of the same parts as those of the first embodiment will be omitted, and only differences will be described.

### Manual Setting of Attachment State

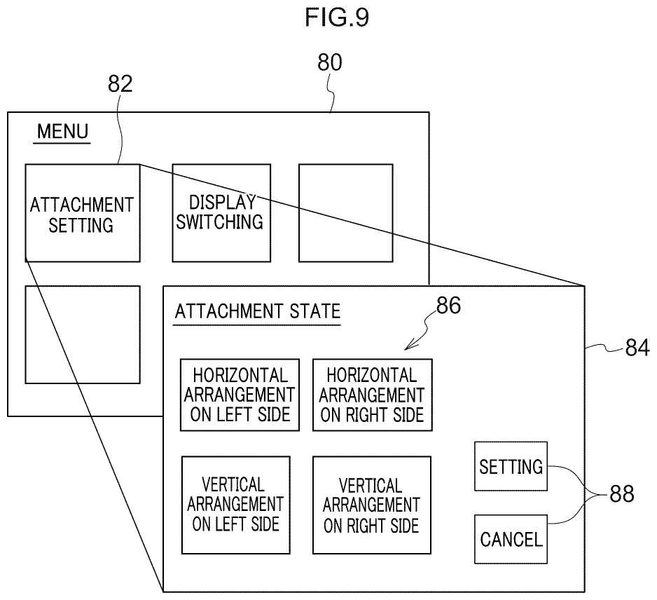

The attachment state of display device 14 may be set by, for example, operating a setting screen 84 illustrated in FIG. 9 displayed on the display unit 40 of the display device 14. By selecting attachment setting on the menu screen 80, the screen shifts to the setting screen 84. The setting screen 84 includes a selection unit 86 for selecting an attachment state, various instruction buttons 88, and the like. For example, as illustrated in FIG. 2C, in the case that display device 14 is attached to the right side of the meter display in the horizontal arrangement, the setting of the attachment state is completed when horizontal arrangement on right side is selected and the setting button is pressed.

### Arrangement Layout of Additional Screen

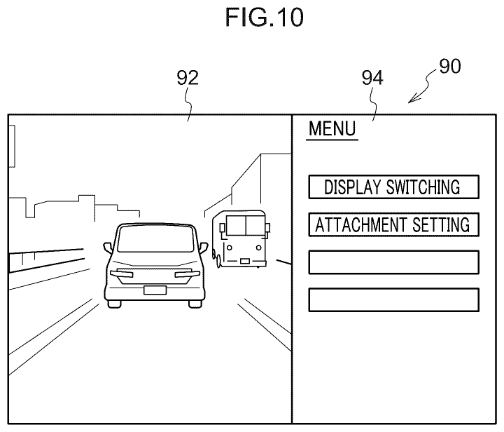

For example, as illustrated in FIG. 10, the display area 90 of the display device 14 may be divided into two, and an image display screen 92 for displaying an image and an additional screen 94 such as a menu screen may be displayed side by side vertically or horizontally. In the present embodiment, an arrangement layout of the additional screen 94 is determined according to the attachment state of the display device.

### Generation Processing of Display Image Data

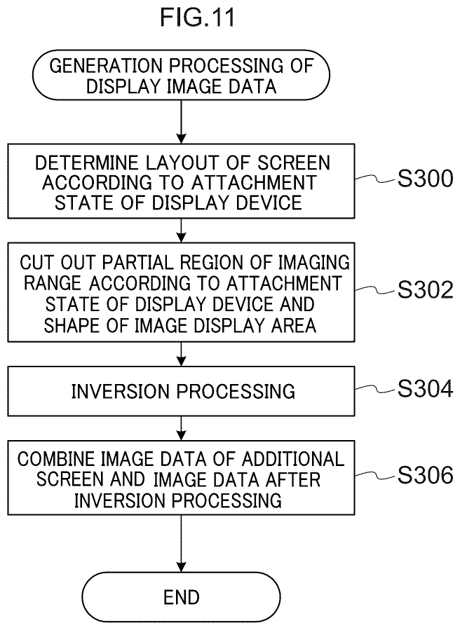

Next, a flow of generation processing of display image data according to the second embodiment will be described with reference to FIG. 11. This processing is executed in step S104 of the image display program illustrated in FIG. 6.

First, in step S300, the display image data generation unit 64 determines the arrangement layout of the additional screen according to the attachment state of the display device.

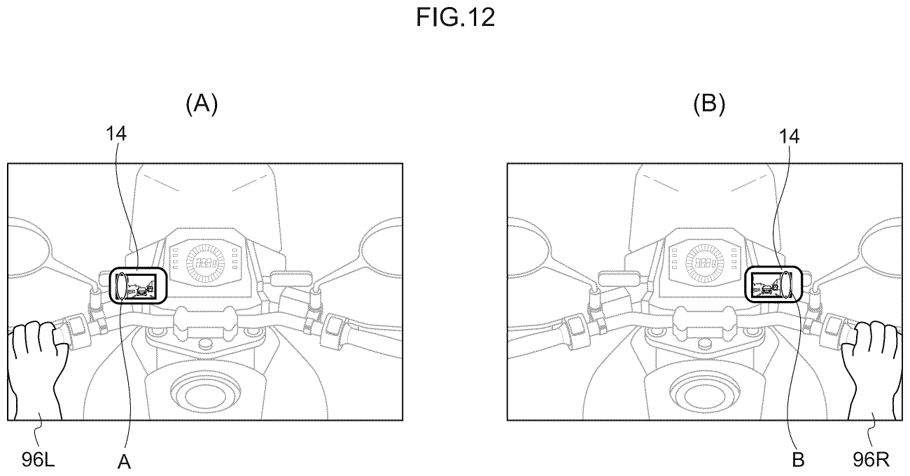

In the example illustrated in FIG. 12, the display device 14 is attached horizontally, and a rider's hand 96 (that is, a right hand 96R and a left hand 96L) holding a steering wheel is also illustrated. For example, when the display device 14 is attached to the left side of the center panel, the additional screen is disposed on the left side (for example, a region A surrounded by a solid line) close to the grip. In addition, in a case where the display device 14 is attached to the right side of the center panel, the additional screen is arranged on the right side (for example, a region B surrounded by a solid line) close to the grip.

Since the imaging device 12 is arranged at the center of the vehicle body, the image display system can provide an image that does not give a rider an unnatural feeling by arranging the display device 14 at the center of the vehicle body. However, in practice, as illustrated, the display device 14 is arranged to be shifted outward from the center of the vehicle body. By arranging the additional screen on the side close to the grip and arranging the image display area on the center side of the vehicle body, it is possible to reduce the offset amount between the imaging device 12 and the display image in the left-right direction.

In addition, in a case where the additional screen is the operation screen, by arranging the additional screen on the side close to the grip, the movement amount of the hand 96 of the rider can be reduced, and the operability is improved. Conversely, in a case where the additional screen is arranged on the side far from the grip, there is a possibility that the image is hidden by the rider's hand 96 at the time of operation.

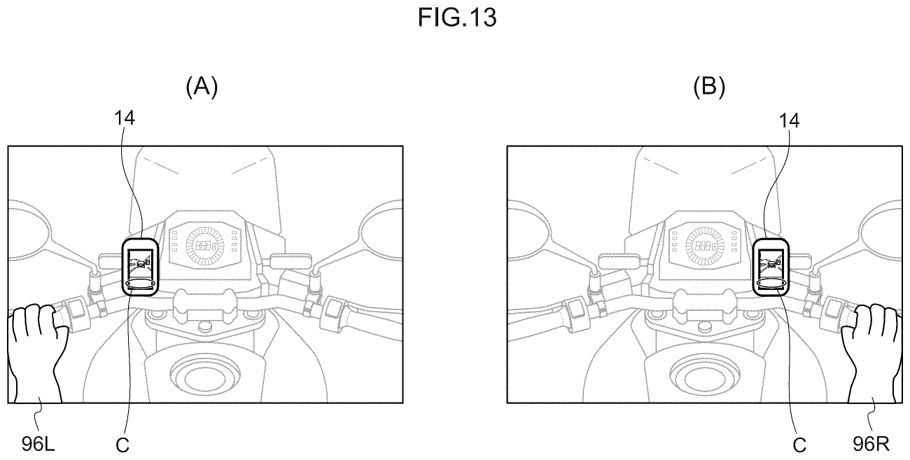

In the example illustrated in FIG. 13, the display device 14 is attached vertically. Also in this case, for the same reason as in the case of the horizontal arrangement, the additional screen is arranged on the lower side (for example, a region C surrounded by a solid line) close to the grip.

Here, the description returns to FIG. 11. Next, in step S302, the display image data generation unit 64 performs image processing on the captured image data so as to cut out a partial region of the imaging range as the display range according to the attachment state of the display device and the shape of the image display area, and in subsequent step S304, performs image processing on the obtained image data so as to laterally invert the image of the display range. Note that the order of step S302 and step S304 may be switched.

The display range is cut out so as to hold the central portion of the imaging range, which is similar to the first embodiment. In the second embodiment, since the shape of the image display area is changed as a result of displaying the additional screen, the display image data generation unit 64 cuts out the display range so as to hold the central portion of the imaging range according to the shape of the image display area. In addition, as in the first embodiment, the display image data generation unit 64 may detect an object (for example, a following vehicle or the like) in a blind spot area and cut out the display range such that the object is displayed at the center.

Next, in step S306, the display image data generation unit 64 combines the image data after the inversion processing and the image data of the additional screen to generate the display image data, and ends the routine. As illustrated in FIG. 10, the image data and the image data of the additional screen are combined so that the image display screen 92 and the additional screen 95 are displayed side by side, that is, a composite image of the image of the display range and the additional screen is displayed.

Note that, in the above description, an example has been described in which the image display system displays the additional screen 94 regardless of whether the display device 14 is attached in the vertical arrangement or the horizontal arrangement. However, for example, the image display system may display the image display screen 92 and the additional screen 94 when the attachment state of the display device 14 is the horizontal arrangement, and may display only the image display screen 92 without displaying the additional screen 94 when the attachment state of the display device 14 is the vertical arrangement. Conversely, the image display system may display the image display screen 92 and the additional screen 94 only when the attachment state of the display device 14 is the vertical arrangement.

Furthermore, in the above description, an example has been described in which the image display system displays the image display screen 92 and the additional screen 94 side by side in the display area 90 of the display device 14. However, the image display system may display an image on the entire surface of the display area 90 of the display device 14 and superimpose and display the additional screen 94 on the image. Also in this case, the image display system determines the arrangement layout of the additional screen 94, that is, the position at which the additional screen 94 is to be superimposed on the upper, lower, right, or left position of the image according to the attachment state of the display device.

As described above, according to the image display system according to the second embodiment, the same effect as that of the first embodiment can be obtained, and the additional screen can be displayed together with the image while displaying the image suitable for the rear check. In addition, the user can manually set the attachment state of the display device. In the case of manual setting, the user can set the attachment state of the display device in detail including the distinction between right and left sides. Even when the display device does not include an acceleration sensor or the like, the user can set the attachment state of the display device.

### Third Embodiment

In the first embodiment, an example in which the image display system automatically determines the attachment state of the display device based on the detection data of the acceleration sensor of the display device has been described, but in a third embodiment, an example in which the display device and the bracket include a mechanism for detecting the attachment state of the display device will be described. This mechanism is also an example of a detection mechanism that detects the orientation of the display device.

The third embodiment is different from the first embodiment in a method of detecting an attachment state of a display device. Therefore, description of the same parts as those of the first embodiment will be omitted, and only differences will be described.

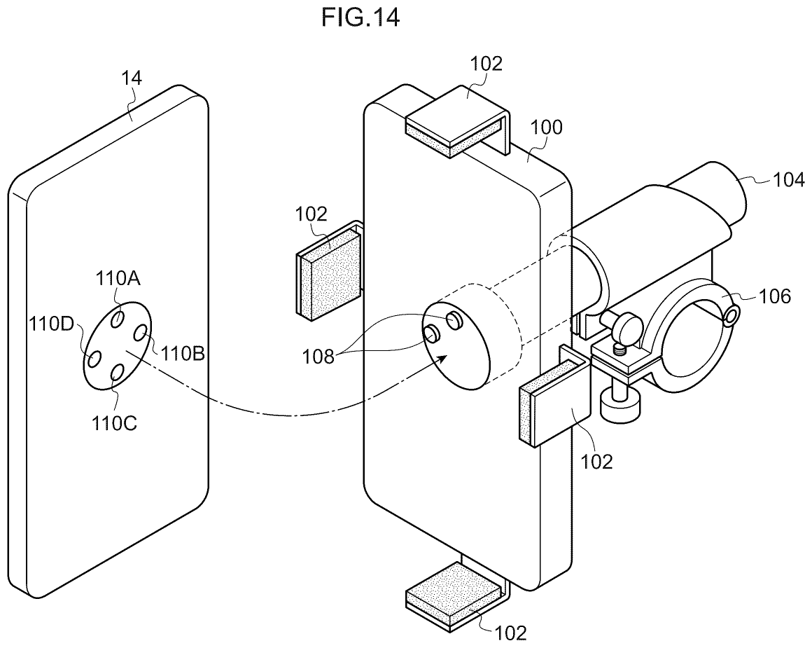

As illustrated in FIG. 14, a bracket 15A is configured such that two protrusions 108 are provided at an end of the support portion 104 exposed from a circular hole of the holding portion 100, and rotation of the holding portion 100 is prohibited when the display device 14 is once fixed to the holding portion 100. Therefore, after the display device 14 is attached to the bracket 15A, the display device 14 cannot be rotated. The bracket 15A has the same configuration as the bracket 15 illustrated in FIG. 3 except for these two points. The same components are denoted by the same reference numerals, and the description thereof will be omitted. In the third embodiment, four switch buttons 110A to 110D are provided on the back surface of the display device 14.

In this detection mechanism, when the display device 14 is attached to the bracket 15A, two of the four switch buttons 110A to 110D provided on the back surface of the display device 14 are pressed by the two protrusions 108. Since the switch button to be pressed varies depending on the attachment state of display device 14, the attachment state of display device 14 can be detected depending on which switch button is pressed.

Since the back surface of the display device 14 needs to be in contact with the holding surface of the holding portion 100 of the bracket 15A, the wiring of the display device 14 is preferably drawn out from the side surface of the display device 14 toward the center of the vehicle body.

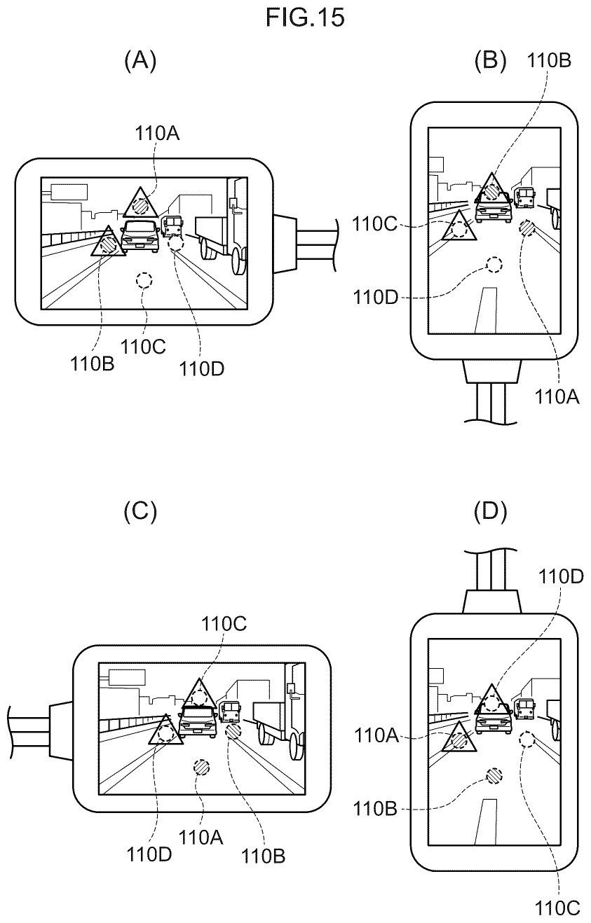

As illustrated in FIG. 15, a triangular mark is put on the switch button pressed by the two protrusions 108. Here, focusing on the switch buttons 110A and 110B, a state in which the switch button is pressed is referred to as ON, and a state in which the switch button is not pressed is referred to as OFF.

In FIG. 15A, the display device 14 is disposed horizontally long on the left side of the meter display (see FIG. 2A). In this case, both the switch buttons 110A and 110B are in the ON state. In FIG. 15B, the display device 14 is disposed in a vertically long manner on the left side of the meter display (see FIG. 2B). In this case, the switch button 110Ais in an OFF state, and the switch button 110B is in an ON state

In FIG. 15C, display device 14 is disposed horizontally long on the right side of the meter display (see FIG. 2C). In this case, both the switch buttons 110A and 110B are in the OFF state. In FIG. 15D, display device 14 is disposed vertically on the right side of the meter display (see FIG. 2D). In this case, the switch button 110A is in an ON state, and the switch button 110B is in an OFF state

In other words, the control device 16 can acquire information on the ON/OFF states of the two switch buttons 110A and 110B and determine which one of the four attachment states is in from the acquired information. That is, the attachment state of the display device is uniquely determined depending on how the display device is attached.

The combination of the number of the protrusions 108 and the number of the switch buttons 110 is not limited to the example. For example, in a case where there is one protrusion 108, the four attachment states can be distinguished from the ON/OFF states of the four switch buttons 110A to 110D.

As described above, according to the image display system according to the third embodiment, the same effects as those of the first embodiment can be obtained, and the attachment state can be detected by a mechanical mechanism when the display device is attached. For example, even when the display device does not include an acceleration sensor or the like, the attachment state of the display device can be automatically determined.

### Modification

Note that the configuration of the image display system described in each of the above embodiments is an example, and it goes without saying that the configuration may be changed without departing from the gist of the disclosure.

In the above embodiment, an example in which the display device is installed on the right side or the left side of the meter display of the instrument panel has been described, but the display device may be installed at a position in front of the rider where the rider can easily see regardless of the presence or absence of the meter display. For example, the display device may be installed on a steering wheel, on an attachment portion of a mirror, on an upper portion of a fuel tank, in a cowl, or on an upper side of a meter display.

In the above embodiment, an example in which a dedicated display device is provided in the image display system has been described, but a portable information processing device such as a smartphone or a tablet may be used as the display device. In this case, the portable information processing device executes various processes in cooperation with the ECU that is the control device, using the installed dedicated application program. For example, the smartphone is wirelessly connected to the communication unit 22 by Bluetooth (registered trademark), and can display an image based on the image data stored in the storage unit 24 on the screen of the smartphone (see FIG. 4).

The present application claims priority from Japanese Patent Application No. 2022-207658 filed on Dec. 23, 2022, the entire disclosure of which is incorporated herein by reference.

1. An image display system comprising:
an imaging device that images an area behind a motorcycle;
a display device that is attached to the motorcycle so as to be located in front of a rider, and is attachable with a changed orientation or is capable of changing an orientation in an attachment state, and that displays an image based on image data acquired from the imaging device; and
a control device that is configured to control the display device so as to cut out a region determined according to the attachment state of the display device from an imaging range of a captured image imaged by the imaging device, and display an image corresponding to the cut out region.

2. The image display system according to claim 1, wherein the region is a horizontally long region when the attachment state of the display device is a horizontal arrangement, and the region is a vertically long region when the attachment state of the display device is a vertical arrangement.

3. The image display system according to claim 1, wherein the display device includes a detection mechanism that detects an orientation of the display device, and the control device is configured to cut out the region determined according to the attachment state of the display device, based on a detection result of the detection mechanism.

4. The image display system according to claim 1, any wherein the control device is configured to cut out the region determined according to the attachment state of the display device such that a magnification of the image displayed on the display device is constant regardless of whether the attachment state of the display device is a horizontal arrangement or a vertical arrangement.

5. The image display system according to claim 1, wherein the control device is configured to control the display device to display an additional screen together with the image cut out from the captured image when the attachment state of the display device is one of a horizontal arrangement or a vertical arrangement, and to display the image cut out from the captured image without displaying the additional screen when the attachment state of the display device is another of the horizontal arrangement or the vertical arrangement.

6. The image display system according to claim 5, wherein, when the additional screen is displayed together with an image of the area behind the motorcycle, the control device is configured to control the display device such that the image cut out from the captured image is arranged on a center side of a vehicle body with respect to the additional screen.
